(19) United States
(12) Patent Application Publication
(10) Pub. No.: US 2004/0051638 A1
(43) Pub. Date: Mar. 18, 2004

(54) Remote control locator

(76) Inventor: Jason Green, Calgary (CA)

Correspondence Address: STURM & FIX LLP, 206 SIXTH AVENUE, SUITE 1213, DES MOINES, IA, 50309-4076, US

(21) Appl. No.: 10/241,905

(22) Filed: Sep. 12, 2002

(51) Int. Cl. G08B 1/08

(52) U.S. Cl. 340/539.32

(57) ABSTRACT

A remote control locator including a sending unit placed at a convenient location in the home and a receiving unit attached to the remote control. The locator is based on OOK (on-off keying) modulation which is a very economical alternative to FM transmission.

### CROSS REFERENCE TO RELATED APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### BACKGROUND OF THE INVENTION

1. Field of the Invention

The present invention relates to the field of locator devices, and more particularly for a digital electronic device to assist consumers in finding misplaced remote controls.

2. Description of Related Art

As can be seen by reference to the following U.S. Pat. Nos. D345,932; D346,339; D349,662; D352,669; D367,017; D388,721; 4,101,873; 5,204,657; 5,294,915; 5,598,143 and 5,790,021, the prior art is replete with myriad and diverse locator devices.

While all of the aforementioned prior art constructions are more than adequate for the basic purpose and function for which they have been specifically designed, they are uniformly deficient with respect to their failure to provide a simple, efficient, and practical remote control locator.

As a consequence of the foregoing situation, there has existed a longstanding need for a new and improved remote control locator and the provision of such a construction is a stated objective of the present invention.

### BRIEF SUMMARY OF THE INVENTION

Briefly stated, the present invention provides a remote control locator including a sending unit placed at a convenient location in the home and a receiving unit attached to the remote control. The locator is based on OOK (on-off keying) modulation which is a very economical alternative to FM transmission.

### BRIEF DESCRIPTION OF THE SEVERAL VIEWS OF THE DRAWINGS

These and other attributes of the invention will become more clear upon a thorough study of the following description of the best mode for carrying out the invention, particularly when reviewed in conjunction with the drawings, wherein:

FIG. 1 is a perspective view of the remote control locator of the present invention including a sending unit adapted to be attached to any household item, and a receiving unit adapted to be attached to a remote control;

FIG. 2 is a schematic diagram of the sending unit; and

FIG. 3 is a schematic diagram of the receiving unit.

### DETAILED DESCRIPTION OF THE INVENTION

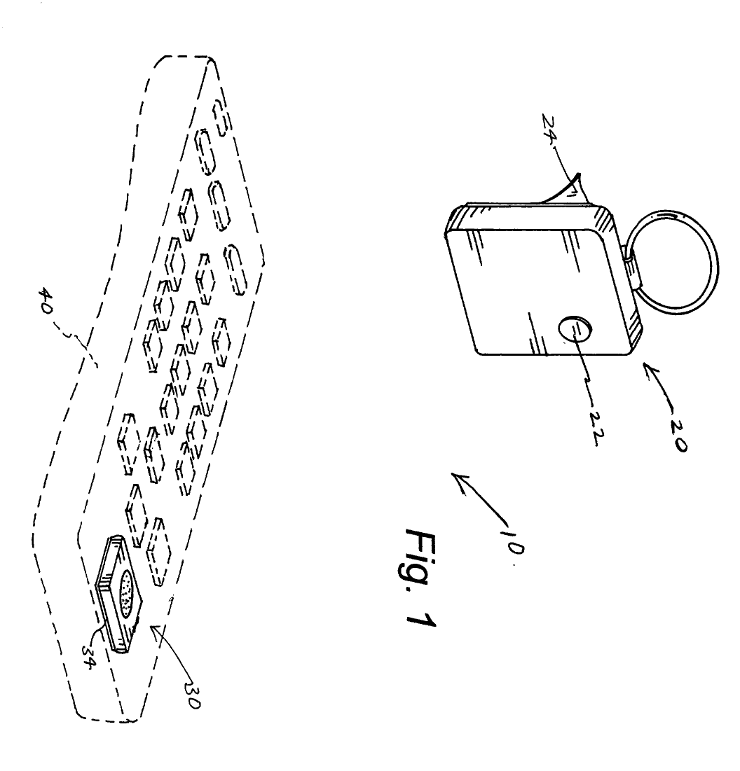

As can be seen by reference to the drawings, and in particularly to FIG. 1, the remote control locator that forms the basis of the present invention is designated generally by the reference number 10. The remote control locator 10 is a new and technologically advanced digital product designed to assist consumers in finding misplaced remote controls. The locator 10 is fundamentally comprised of two units. The first unit is the sending unit 20 which simply has a push button 22 to activate the system. This unit 20 can be attached to any household item such as the individual's TV, home entertainment system, coffee table, end tables, headboard or other convenient location. This attachment is made via the use of two-sided tape 24 on the back of the unit 20 or any other suitable means. The unit 20 itself is smaller than one square inch making it unobtrusive in the home. The second unit is the receiving unit 30 which responds to the sending unit 20 when that unit is activated. The receiving unit 30 is designed to easily attach to any remote controller 40, again via two-sided tape 34 on the back of the unit 30 or any other suitable means. This unit 30 is even smaller than the sending unit 20 and therefore it will not interfere with the aesthetics and operation of the remote control 40. When the receiving unit 30 is activated, it emits a series of beeps which assist the consumer in locating the lost remote control unit 40.

Both units come packaged together and due to the high technology of the system, further receiving units can be purchased for consumers who have more than one remote control in their home. The sending unit's technology is capable of distinguishing between different receiving units and is multi-function programmable.

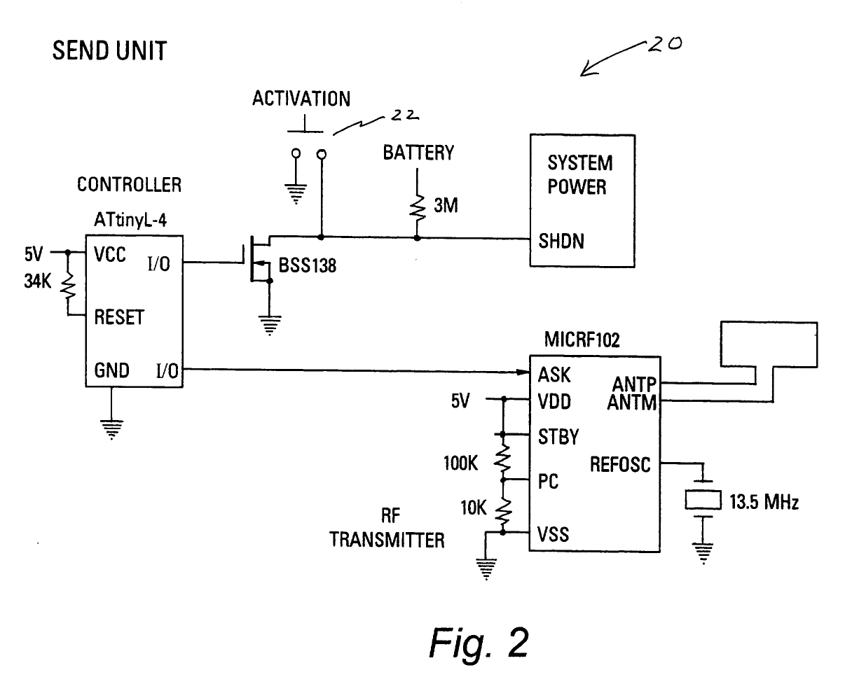

The sending unit 20 is shown schematically in FIG. 2. The unit 20 includes a press button 22 which activates the SHDN pin on the power supply, causing the micro-controller to power up. The micro-controller immediately turns on the transistor (BSS138), thus holding the power on, even though the button 22 is released. For the next 10 seconds, it sends a modulating signal to the transmitter (MICRF102) at a steady frequency. This allows the receiver 30 several attempts to detect the signal, as the receiver 30 wakes up every 0.7 seconds. The micro-controller then releases the transistor, removing power from the entire system.

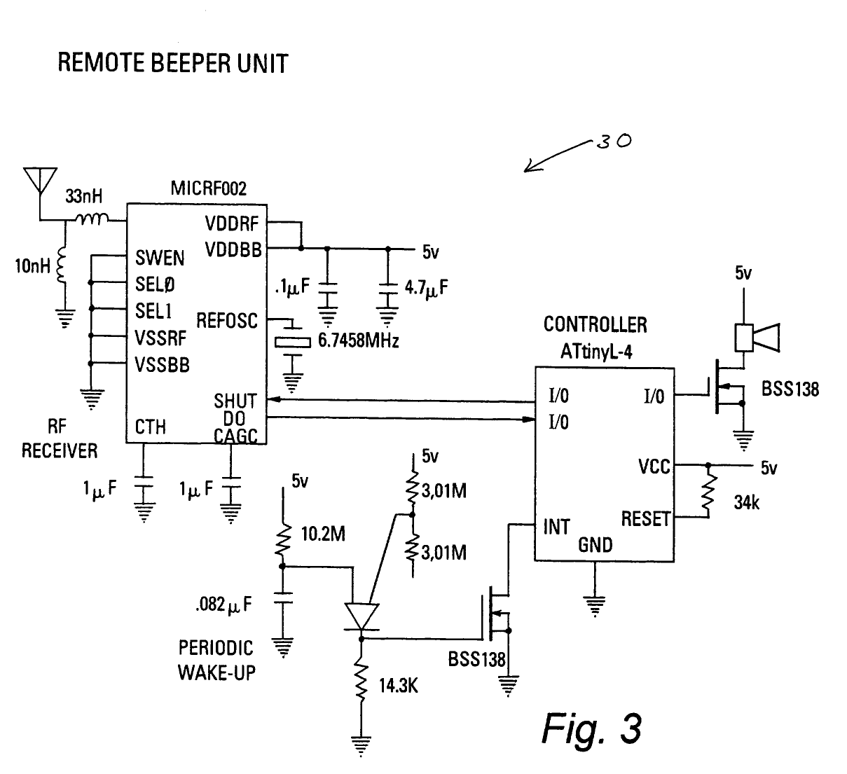

The sending unit 30 as shown in FIG. 3 has a periodic wake-up circuit which is an extremely low-power function that simply sends a pulse to the interrupt pin of the micro-controller every 0.7 second. When the micro-controller wakes up, it immediately powers up the receiver (SHUT pin) and executes a carefully timed analysis of the incoming signal (DO pin). The analysis is designed to distinguish between random signals or intrinsic noise and the expected frequency signal from the send unit. If the proper signal is detected, the micro-controller begins a timed activation of the beeper. In either case, the final step is to shut down the receiver and enter the sleep mode to await the next interrupt.

The locator 10 is based on OOK (on-off keying) modulation (MICRF002 and MICRF102). OOK is a very economical alternative to FM transmission.

OOK permits software optimization to achieve lower power consumption. When the signal is in the “off” state, very little power is consumed; whereas with FM modulation, during transmission, full power is consumed constantly regardless of the state of the signal. Up to this time, the principal constraints governing the feasibility of a consumer product of this type are component cost and compactness of the receiver. Low cost has been difficult to achieve because of the sheer number of components required to implement discrete transmitter and receiver circuits. Compact size has been limited by the carrier frequency: lower frequencies require longer antennas while higher frequencies come at higher development cost.

The locator 10 of the present invention makes use of recently available integrated circuits that consolidate the numerous RF components on a single chip. This significantly reduces the cost of the circuit, but also enables the use of much higher frequencies. Taken together, these features are exploited to produce a simplified design that meets the requirements of the market.

Although only an exemplary embodiment of the invention has been described in detail above, those skilled in the art will readily appreciate that many modifications are possible without materially departing from the novel teachings and advantages of this invention. Accordingly, all such modifications are intended to be included within the scope of this invention as defined in the following claims.

1. A remote control locator, comprising:
a sending unit based on OOK modulation; and
a receiving unit based on OOK modulation and being associated with a remote control.

2. The remote control locator of claim 1 wherein the sending unit sends a modulated signal to a transmitter at a steady frequency for a fixed time interval.

3. The remote control locator of claim 1 wherein the receiving unit sends a pulse to an interrupt pin of a microprocessor every 0.7 seconds.

4. The remote control locator of claim 2 wherein the receiving unit sends a pulse to an interrupt pin of a microprocessor every 0.7 seconds.

5. The remote control locator as in claim 1, wherein said receiving unit is attached to a remote control.

6. The remote control locator as in claim 1, wherein said receiving unit is formed integrally with a remote control.

7. The remote control locator as in claim 2, wherein said fixed time interval is approximately ten (10) seconds.
